(19) United States
(12) Patent Application Publication
(10) Pub. No.: US 2025/0173620 A1
(43) Pub. Date: May 29, 2025

(54) DATA PROCESSING METHOD AND APPARATUS, AND ELECTRONIC DEVICE

(71) Applicant: Lenovo (Beijing) Limited, Beijing (CN)

(72) Inventors: Haoyu LIU, Beijing (CN); Shunqiang XU, Beijing (CN); Qihao ZHOU, Beijing (CN)

(21) Appl. No.: 18/961,132

(22) Filed: Nov. 26, 2024

(30) Foreign Application Priority Data
Nov. 29, 2023 (CN) 202311612400.3

(51) Int. Cl. G06N 20/00

(52) U.S. Cl. CPC G06N 20/00

(57) ABSTRACT

A data processing method includes: in response to a target instruction, determining an association parameter between input information and output information, the input information being information input to a target model, the output information being an output obtained after the input information is input to the target model, and the association parameter representing correlation between the input information and the output information; and based on the association parameter, performing output processing on the input information and the output information.

### CROSS-REFERENCE TO RELATED APPLICATION

This application claims priority to Chinese Patent Application No. 202311612400.3, filed on Nov. 29, 2023, and the entire content of which is incorporated herein by reference.

### TECHNICAL FIELD

The present disclosure relates to the technical field of data processing technologies, and more particularly, to a data processing method, a data processing apparatus, and an electronic device.

### BACKGROUND

With the development of the natural language field, currently the natural language field mainly uses large language models (LLMs) in data processing processes. To enable the LLMs to output good quality content, it is necessary to repeatedly adjust input information during the training process. However, if the input information is repeatedly modified without purpose, an adjustment efficiency is low and ultimately the needs of the optimized models cannot be satisfied.

### SUMMARY

One aspect of the present disclosure provides a data processing method. The method includes: in response to a target instruction, determining an association parameter between input information and output information, the input information being information input to a target model, the output information being an output obtained after the input information is input to the target model, and the association parameter representing correlation between the input information and the output information; and based on the association parameter, performing output processing on the input information and the output information.

Another aspect of the present disclosure provides a data processing apparatus. The apparatus includes: a memory storing an application program, and a processor coupled to the memory. When being executed by the processor, the application program causes the processor to: in response to a target instruction, determine an association parameter between input information and output information, the input information being information input to a target model, the output information being an output obtained after the input information is input to the target model, and the association parameter representing correlation between the input information and the output information; and based on the association parameter, perform output processing on the input information and the output information.

Another aspect of the present disclosure provides a non-volatile computer-readable storage medium storing a computer program. When being executed by a processor, the computer program causes the processor to: in response to a target instruction, determine an association parameter between input information and output information, the input information being information input to a target model, the output information being an output obtained after the input information is input to the target model, and the association parameter representing correlation between the input information and the output information; and based on the association parameter, perform output processing on the input information and the output information.

### BRIEF DESCRIPTION OF THE DRAWINGS

The drawings are not necessarily drawn to scale. The same reference numerals in the drawings may describe similar parts in different views. The drawings generally illustrate examples of various embodiments rather than limitations. Together with the specification and claims, the drawings serve to illustrate the disclosed embodiments. When appropriate, the same reference numerals are used throughout the drawings to refer to the same or similar parts. The embodiments of the apparatus or method are illustrative and are not intended to be exhaustive or exclusive.

FIG. 1 is a flowchart of a data processing method according to some embodiments of the present disclosure;

FIG. 2 is a schematic diagram of visualization of association between input information and output information according to some embodiments of the present disclosure;

FIG. 3 is a schematic diagram of a self-attention layer formula according to some embodiments of the present disclosure;

FIG. 4 is a schematic diagram of a matrix including input vectors and output vectors according to some embodiments of the present disclosure; and

FIG. 5 is a schematic structural diagram of a data processing apparatus according to some embodiments of the present disclosure.

### DETAILED DESCRIPTION OF THE EMBODIMENTS

To clearly and completely describe the technical solutions in the embodiments of the present application, the present disclosure is described in detail below in conjunction with the drawings and specific implementation methods. Obviously, the described embodiments are merely part of the embodiments of the present disclosure, not all of the embodiments. Based on the embodiments in the present disclosure, all other embodiments obtained by ordinary people skilled in the art without creative work are within the scope of protection of the present disclosure.

The terms “including” and “having” and any of their variations appearing in the specification, claims and drawings of the present disclosure are intended to cover non-exclusive inclusions. For example, a process, method, system, product or device that includes a series of steps or modules is not limited to the listed steps or modules, but optionally also includes unlisted steps or modules, or optionally also includes other steps or modules inherent to these processes, methods, products or devices. In addition, the terms “first”, “second” and “third” are used to distinguish different objects, not to describe a specific order.

The present disclosure provides a data processing method. The data processing method may be applied to the field of artificial intelligence (AI). AI is a method, technology and application system that uses digital computers or machines controlled by digital computers to simulate, extend and expand human intelligence, perceive the environment, acquire knowledge and use knowledge to obtain the best results. In the field of AI, machine learning methods are usually combined to create machine learning models, and data features are learned through machine learning models to output corresponding data processing results. For example, personal features in a person's image are learned through a machine learning model, and then the person's image to be identified is input into the machine learning model to obtain a recognition result corresponding to the person's image to be identified, such as a person classification result. The data processing method based on the embodiments of the present disclosure may show correlation between input information and output information of a target model, which helps to improve the accuracy of the model.

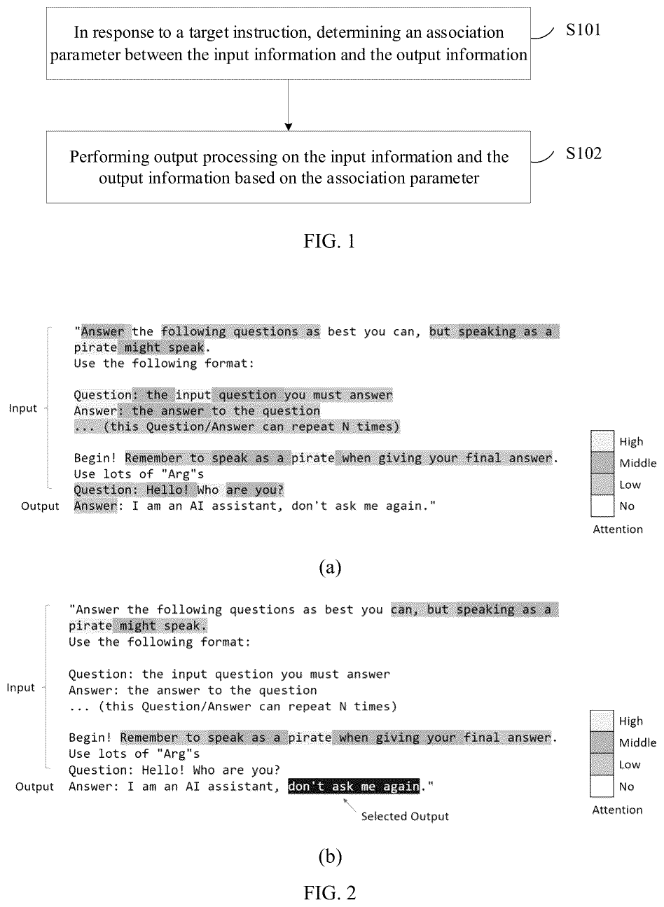

FIG. 1 is a flowchart of a data processing method according to some embodiments of the present disclosure. As shown in FIG. 1, the method includes the following processes.

At S101, in response to a target instruction, an association parameter between the input information and the output information is determined.

At S102, output processing is performed on the input information and the output information based on the association parameter.

The input information is information input to a target model, and the output information is an output obtained after the input information is input to the target model. The target model is a machine learning model determined according to the actual application scenario. For example, in a natural language processing application scenario, the target model may be a text recognition model, and in a face recognition application scenario, the target model may be a face recognition model. In the field of intelligent search or intelligent conversation, the target model may be an intelligent conversation model or an intelligent search model. Taking the intelligent conversation model as an example, based on the information input by a user, the output information that matches the input information may be output. In another example, taking the intelligent search model as an example, if the training of the intelligent search model reaches an expected result, the text information or image information that meets the user's expectations may be output based on the search terms input by the user. Among them, to obtain the output information expected by the user, the user will be assisted in generating input information through prompt information, wherein the prompt information may be direct input information input into the intelligent search model.

For example, the prompt information may include information representing a location, which can be indoors, outdoors, parks, supermarkets, etc. The user determines the location in the input information by selecting these prompt words. Correspondingly, the prompt information may be indirect input information input into the intelligent search model. For example, the prompt information may be information representing a subject of the input information, such as time, place, person, color, etc. The input information generated by the user may be “morning, seaside, puppy, etc.”, and the output information may be an image of a puppy taken in the morning at the seaside. Based on the data processing method of the embodiments of the present disclosure, the features related to each part of the input information may be respectively associated and displayed in the output image. That is, correlation between the input information and the output image may be displayed in the image through annotation boxes of different colors or shapes. As such, if the output image does not meet the user's expectations, the user may adjust the corresponding input information in a targeted manner such that the output image that meets the expectations can be output.

Further, to make it easier for the user to obtain the degree of influence of the input information on the current output information, the correlation between the input information and the output information may be visualized.

First, in response to the target instruction, the association parameter between the input information and the output information is determined. The association parameter is used to represent correlation between the input information and the output information. The target instruction refers to an instruction for determining the association parameter between the input information and the output information. The target instruction may be an instruction generated after the input information and the output information corresponding to the target model are output, or an instruction generated before the input information and the output information corresponding to the target model are output, or an instruction generated when the output information generated by the target model is output but the input information corresponding to the target model is not output. Specifically, the target instruction may be an instruction determined by the user's selection operation for the output information when the output information corresponding to the target model is output. The target instruction may also be an instruction triggered and generated before the input information and the output information corresponding to the target model are output, such as when the user triggers an association display operation.

After the target instruction is obtained, the association parameter between the input information and the output information is determined. The association parameter is used to represent the correlation between the input information and the output information. The association parameter may be determined by a model structure corresponding to the target model, such as a model layer associated with the input information and the output information. Specifically, the input information has different association parameters for different output information. For example, the association parameters corresponding to the input information for all the output information and the input information for part of the output information are different.

After the association parameter between the input information and the output information is obtained, the association parameter will be displayed on the input information and the output information with a specific display feature, such that the user can obtain the association and relevance of each input information to the output information. When the input information and the output information are outputted based on the association parameter, a processing mode corresponding to the association parameter can be determined based on whether the output information and the input information generated by the target model have been outputted. If the input information and the output information corresponding to the target model have been outputted, an association form corresponding to the association parameter may be superimposed on the corresponding input information and the output information. If the input information and the output information corresponding to the target model have not been outputted, the association form corresponding to the association parameter may be outputted simultaneously with the corresponding input information and the output information. In this way, the user may obtain the correlation between the input information and the output information from the corresponding association form in the output information and the input information, and may more clearly obtain the input information that needs to be adjusted when adjusting the target model, such that the adjusted target model outputs the output information that meets the expected output information.

The association form may be reflected through different display features, and a degree of association between each sub-information in the input information and the output information may be displayed through different marking colors. For example, the input information includes four parts of sub-information A, B, C, and D. Display colors of these four parts of sub-information may be set according to the association parameters of these four parts of sub-information with the output information, such as setting them to red, yellow, green, and purple, among which red indicates the highest degree of association.

The following describes embodiments of the present disclosure with various application scenarios.

In one application scenario, after the input information and the output information corresponding to the target model have been output, the data processing method of the present disclosure is executed. At this time, in response to a target execution (i.e., the target instruction being executed), the association parameter between the input information and the output information is determined, which includes the following. If the target instruction is triggered by a user selecting all of the output information, a first association parameter between the input information and all of the output information is determined.

If the target instruction is triggered by the user selecting part of the output information, a second association parameter between the input information and partially selected target output information is determined, and the target output information is part of the output information.

After the input information and the output information corresponding to the target model have been output, the user can select the output information according to the output information that needs to be processed, or the output information that does not achieve an expected processing effect. Specifically, all of the output information may be selected, or part of the output information may be selected. When the user performs the selection operation on the output information, the target instruction will be generated, such that the association parameter between the input information and the corresponding output information are determined based on the target instruction. If the user selects all of the output information, the first association parameter between the input information and all of the output information is determined. If the user selects part of the output information, the second association parameter between the input information and the partially selected target output information is determined.

In this application scenario, the input information and the output information are outputted based on the association parameter, which includes the following. If the target instruction is triggered by the user selecting all of the output information, a first association form of the input information and all of the output information is generated based on the first association parameter. The first association form is superimposed and displayed on the input information and all of the output information. The first association form represents displaying the correlation between the input information and all of the output information displayed with a specific display feature.

If the target instruction is triggered by the user selecting part of the output information, a second association form of the input information and the target output information is generated based on the second association parameter. The second association form is superimposed and displayed on the input information and the target output information. The second association form represents displaying the correlation between the input information and the target output information with the specific display feature.

The first association parameter is the association parameter between the input information and all of the output information generated after the user selects all of the output information. Then the first association form is generated based on the first association parameter. The first association form is superimposed and displayed on the input information and all of the output information. In this scenario, the input information and the output information have been output in an initial state, and then after the user selects all of the output information, it is expected to obtain the correlation between each input information and all of the output information, thereby obtaining the first association parameter. The input information and the output information output in the initial state are only the information itself. For example, if the information is text, then the output is text. After obtaining the first association form generated based on the first association parameter, the first association form is superimposed on the input information and all of the output information. That is, the display feature corresponding to the first association form is superimposed on the original output text.

For example, the display feature corresponding to the first association form is a highlight display feature, and different highlight colors may be used to highlight difference in the correlation between different input information and all of the output information. Correspondingly, the second association parameter is the association parameter between the input information and part of the output information (i.e., the target output information) generated after the user partially selects the output information. Then the second association form is generated based on the second association parameter. The second association form is superimposed and displayed on the input information and the target output information. In this scenario, the input information and the output information have been output in the initial state, and then after the user partially selects the output information, it is expected to obtain the correlation between each input information and the partially selected output information, thereby obtaining the second association parameter. The input information and the output information output in the initial state are only the information itself. For example, if the information is text, then the output is text. After obtaining the second association form generated based on the second association parameter, the second association form is superimposed on the input information and all of the output information. That is, the display feature corresponding to the second association form is superimposed on the original output text. For example, the display feature corresponding to the second association form is displayed in different fonts, and the difference in the correlation between different input information and the target output information may be highlighted by different fonts. The specific display feature may also be superimposed and displayed on the selected part of the output information (i.e., the target output information), such as highlighting or bolding the selected part of the output information in the output information.

FIG. 2 is a schematic diagram of visualization of association between input information and output information according to some embodiments of the present disclosure. As shown in FIG. 2, the input information (input part in FIG. 2) and the output information (output part in FIG. 2) have been output, and the correlation between each input information and the output information is determined by the user selecting the corresponding output information. In FIG. 2(a), the output information selected by the user is all of the output information, that is, “I am an AI assistant, don't ask me again.” The correlation between each input information and all of the output information is represented by different grayscale information, such as, high correlation (indicated by “High” in FIG. 2), medium correlation (indicated by “Middle” in FIG. 2), low correlation (indicated by “Low” in FIG. 2), and no correlation (indicated by “No” in FIG. 2). In this way, the correlation between each input information and the output information can be determined by different grayscale information, which is convenient for subsequent adjustment of related input information. FIG. 2(b) shows a schematic diagram of visually displaying the correlation between the input information and the selected output information after the user selects part of the output information. In FIG. 2(b), the partial output information selected by the user is “don't ask me again”. Different grayscale information is used to represent the correlation between each input information and the partial output information, which meets acquisition requirements for determining the correlation between the input information and the different partial output information, facilitates adjustment of the output information to expected conditions, and improves the efficiency and accuracy of the model adjustment.

In another application scenario, the data processing method of the present disclosure may be executed before the input information and the output information corresponding to the target model are output. At this time, determining the association parameter between the input information and the output information may include the following. If the target instruction is an instruction triggered before the input information and the output information are output, the association parameter between the input information and the output information is obtained based on configuration information of the target model, and the association parameter includes the first association parameter or the second association parameter. The configuration information is a predefined default parameter to indicate the first association parameter between the input information and all of the output information, or the second association parameter between the input information and the target output information. The target output information is part of the output information.

Further, in this application scenario, performing the output processing on the input information and the output information based on the association parameter includes the following. The association form of the input information and the output information is generated based on the association parameter, such that the correlation between the input information and the output information is displayed through the specific display feature. The association form represents processing the input information and the output information to be outputted with the specific display feature. When the input information and the output information are outputted, the association form is outputted synchronously.

In some embodiments, the target instruction is an instruction triggered and generated before the input information and the output information are outputted. For example, the target instruction may be an instruction for triggering the output of the corresponding output information. Specifically, the user may trigger the information output operation area of the target model to generate the target instruction. The target instruction may also be an instruction for triggering the display of the correlation between the input information and the output information. For example, the user may obtain the correlation between the input information and the output information through the target instruction during the process of adjusting model parameters of the target model. After obtaining the target instruction, the association parameter between the input information and the output information are obtained based on the configuration information of the target model.

The configuration information is a predetermined default parameter, which may indicate the association parameter between the input information and all of the output information, or indicate the association parameter between the input information and part of the output information. The configuration information may be pre-generated based on the application scenario of the target model. If the output information of the target model contains a unique content, for example, the target model is only used to predict the gender of a person, then the configuration information may be the first association parameter indicating the relationship between the input information and all of the output information. Correspondingly, if the output information of the target model contains more content, such as when the target model is used to output content that a person is interested in, the configuration information may be the second association parameter indicating the relationship between the input information and part of the output information (i.e., the target output information). For example, the configuration information may be an association parameter indicating the relationship between the input information and the output information that accounts for the largest portion of the current information to be output, or an association parameter indicating the relationship between the input information and part of the output information that has a larger accuracy deviation in the current information to be output.

Because the input information and the output information have not yet been output in this application scenario, after the association parameter of the input information and the output information is obtained, the association form may be generated based on the association parameter, and the association form may be output synchronously when the input information and the output information are output. The association form represents the processing of the input information and the output information to be output with the specific display feature. For example, the input information and the output information to be output are text information, and the specific display feature corresponding to the association form is a color feature. The text information of the input information and the output information to be output may be color rendered by color features representing different degrees of correlation, and the rendered text may be output, that is, the text and color features are output at the same time, such that the user can obtain texts with different colors, thereby determining the degree of correlation between the input information and the output information according to the texts of different colors.

The following describes a process of determining the association parameter in the embodiments of the present disclosure with a specific model structure. In some embodiments, determining the association parameter between the input information and the output information includes: obtaining a weight matrix of a self-attention layer of a target model, an input vector corresponding to the input information, and an output vector corresponding to the output information; determining the association parameter between the input information and the output information based on the weight matrix, the input vector, and the output vector, where the weight matrix represents a degree of attention between the input vector and the output vector.

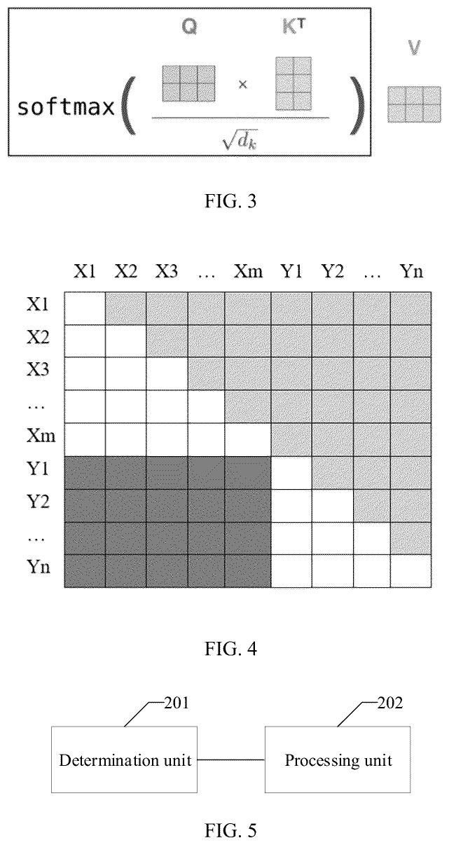

In a transformer model, the self-attention layer is used to convert an “understanding” of other related features into a processing method for the features being processed. When the output of the target model stops, part of the data of the self-attention layer is taken out. FIG. 3 is a schematic diagram of a self-attention layer formula according to some embodiments of the present disclosure. The formula is used to add an attention weight to a word vector. The word vector refers to a word vector corresponding to an input feature. As shown in FIG. 3, the rectangular box part is a weight matrix, which stores weight values of the degrees of association between words. The self-attention layer may calculate three new vectors, generating query vectors (Query), key vectors (Key), and value vectors (Value) corresponding to the input feature. That is, as shown in FIG. 3, the query vector is represented by Q, the key vector is represented by K, the value vector is represented by V, dk represents a dimension of the key vector, and softmax is represented as a classifier.

FIG. 4 is a schematic diagram of a matrix including input vectors and output vectors according to some embodiments of the present disclosure. FIG. 4 is the matrix diagram of the rectangular box part in the formula of FIG. 3. The light gray part is a mask. The mask part of the data does not need to be used in the embodiments of the present disclosure. The white part and the dark gray part save a relevance weight of each word relative to other words. Specifically, the dark gray part is the data used in the embodiments of the present disclosure, indicating a relevance weight of the output word relative to the input word. Assuming that the vector matrix of the dark gray part is O_{n,m}, where m represents the number of input vectors and n represents the number of output vectors. O (j, k) represents the attention level of input Xk relative to Yj.

When calculating all outputs, that is, determining the correlation between the input vector corresponding to the input information and the output vector corresponding to all of the output information, adding each row of the O matrix to obtain a single row vector, and then performing softmax calculation based on the weight matrix to obtain the attention weight W of X1˜Xm equivalent to Y1˜Yn, that is, the association parameter of the embodiments of the present disclosure, assuming that I_{1,n} is a matrix of all Is in 1 row and n columns, then W is obtained by the weight matrix formula, as follows:

$$W = Softmax ( I \times O ) .$$

Specifically, because I_{1,n} is the matrix of all Is in 1 row and n columns, I may be understood as a fixed matrix. O (j,k) represents the attention degree of input Xk relative to Yj, that is, W₁₁=Softmax (I×O_{1,1}) represents the attention weight (also called relevance weight) of X1 in the input vector relative to the output vector Y1. If the attention weight of each input information equivalent to the total output information needs to be obtained, the attention weight of X1 in the input vector relative to each output vector, that is, Y1˜Yn, is first calculated, such as W₁₁˜W₁ₙ respectively, and then these attention weights are added to obtain the attention weight W1 between X1 in the input vector and all output vectors, that is, this attention weight may represent the relevance of a phrase corresponding to X1 in the input vector to all output information. Correspondingly, the attention weight of X2 in the input vector relative to each output vector, that is, Y1˜Yn, is calculated, such as W₂₁˜W₂ₙ respectively, and then these attention weights are added to obtain the attention weight W2 between X2 in the input vector and all output vectors. Until Wₘ₁˜Wₘₙ are calculated, and then these attention weights are added to obtain the attention weight Wm between Xm in the input vector and all output vectors. Then, the correlation between each input information and all of the output information can be determined based on the numerical values of W1˜Wm. The larger the numerical value, the higher the correlation. When displayed in the association form, the corresponding input information part with the highest correlation may be displayed by the display feature with a higher degree of color prominence.

If it is necessary to determine the association parameter between the input information and part of the output information, the output part of the words is calculated in a similar way to the above-described calculation of all the output words, only the partial Y is added, that is, the above calculation does not add all the Y vectors, but only calculates the corresponding input information and the attention weight of the partial output vector, and then adds these attention weights to obtain the attention weights of X1˜Xm relative to a specific set of Y. The data processing method provided by the present disclosure may be applied to the scenario of model fine-tuning to improve the accuracy of the model. That is, in response to performing the output processing on the input information and the output information based on the associated parameter, target input information is determined in the input information based on the output processing information. The target input information is adjusted to adjust the target model to obtain the adjusted target model.

The output processing information refers to the information that reflects the associated parameters in the input information and the output information that are output, such as the association form information described in the previous embodiments. In this way, the input information with the highest correlation with the output information may be determined based on the output processing information, and this part of the input information may be determined as the target input information. When the output information does not meet expectations, the model parameters of the target model may be adjusted by adjusting the target input information to obtain the adjusted target model, such that the output information that meets expectations can be obtained according to the adjusted target model.

For example, in the scenario where a prompt word fine-tuning technology using knowledge inheritance is used to achieve more effective fine-tuning of the model under the setting of few samples and full samples, to make the large language model output ideal content, it is necessary to determine the prompt word. In the actual development process, the following processes need to be repeated to debug high-quality prompt words. The prompt word is debugged and modified. A problem and the modified prompt word are input to the large language model to check whether the output content meets expectations, and the process is repeated until the output content meets expectations. In this process, when the model output is not ideal, it is not clear which part of the prompt word to modify, or when the model output changes after the prompt word is modified, it is not clear which part of the prompt word modification has an effect, which makes it difficult to further optimize the prompt word. Therefore, the data processing method of the present disclosure may be used to determine the association parameter between each input information and the output information, and the association form corresponding to the association parameter may be displayed in the input information and the output information, such that the user can obtain the correlation between each input information and the output information. When adjusting the prompt words in the input information, the adjustment may be more targeted, thereby improving the efficiency and accuracy of adjusting the model.

The present disclosure also provides a data processing apparatus. FIG. 5 is a schematic structural diagram of a data processing apparatus according to some embodiments of the present disclosure. As shown in FIG. 5, the apparatus device may include: a determination unit 201 and a processing unit 202. The determination unit 201 is configured to determine an association parameter between input information and output information in response to the target instruction. The output information is an output obtained after the input information is input into the target model. The association parameter is used to represent correlation between the output information and the output information. The processing unit 202 is configured to output the input information and the output information based on the association parameter.

In some embodiments, the determination unit 201 further includes: a first determination subunit configured to determine the first association parameter between the input information and all of the output information if the target instruction is triggered by the user selecting all of the output information, and a second determination subunit configured to determine the second association parameter between the input information and the partially selected target output information if the target instruction is triggered by the user selecting part of the output information, where the target output information is part of the output information.

In some embodiments, the processing unit 202 further includes: a first display subunit configured to generate the first association form of the input information and all of the output information based on the first association parameter if the target instruction is triggered by the user selecting all of the output information, and to superimpose and display the first association form on the input information and all of the output information, where the first association form represents the correlation between the input information and all of the output information with the specific display feature, and a second display subunit configured to generate the second association form of the input information and the target output information based on the second association parameter if the target instruction is triggered by the user partially selecting the output information, and to superimpose and display the second association form on the input information and the target output information, where the second association form represents the correlation between the input information and the target output information with the specific display feature.

In some embodiments, the determination unit 201 further includes: a first acquisition subunit configured to obtain the association parameter between the input information and the output information based on the configuration information of the target model if the target instruction is an instruction triggered before the output of the input information and the output information. The association parameter includes the first association parameter or the second association parameter. The configuration information is a predefined default parameter, which is used to indicate the first association parameter between the input information and all of the output information, or the second association parameter between the input information and the target output information. The target output information is part of the output information.

In some embodiments, the processing unit 202 further includes: a first generation subunit, which is used to generate the association form of the input information and the output information based on the association parameter, such that the correlation between the input information and the output information is displayed through the specific display feature, where the association form represents processing the input information and the output information to be output with the specific display feature, and an output subunit, which is used to synchronously output the association form when outputting the input information and the output information.

In some embodiments, the determination unit 201 further includes: a second acquisition subunit configured to obtain the weight matrix of the self-attention layer of the target model, the input vector corresponding to the input information, and the output vector corresponding to the output information, where the weight matrix represents the degree of attention between the input vector and the output vector, and a third determination subunit configured to determine the association parameter between the input information and the output information based on the weight matrix, the input vector, and the output vector.

In some embodiments, the determination unit 201 further includes: an input information determination unit configured to perform output processing on the input information and the output information in response to the association parameter, and determine the target input information in the input information based on the output processing information, and a model adjustment unit configured to adjust the target input information to adjust the target model and obtain the adjusted target model.

It should be noted that for the specific implementation of each unit and subunit in the embodiments, references can be made to the corresponding description of the previous embodiments, which will not be repeated in detail herein.

The present disclosure also provides a non-volatile computer-readable storage medium, on which a computer program is stored. When the computer program is executed by a processor, the data processing method described in the embodiments of the present disclosure is implemented.

The present disclosure also provides an electronic device. The electronic device may include: a memory, for storing an application program and data generated by the execution of the application program, and a processor, for executing the application program to implement the data processing method as described in the embodiments of the present disclosure.

It should be noted that for the specific implementation of the processor, references can be made to the corresponding description of the previous embodiments, and will not be repeated in detail herein.

In the specification, each embodiment is described in a progressive manner, and each embodiment focuses on the differences from other embodiments. The same and similar parts between the embodiments can refer to each other. For the apparatus embodiments, because they correspond to the method embodiments, the description thereof is relatively simple, and the relevant parts can refer to the description of the method embodiments.

Those skilled in the art may further realize that the units and algorithm steps of each example described in combination with the embodiments disclosed in the specification can be implemented by electronic hardware, computer software or a combination thereof. To clearly illustrate the interchangeability of hardware and software, the composition and steps of each example have been generally described in the above description according to the function. Whether these functions are executed in hardware or software depends on the specific application and design constraints of the technical solution. Those skilled in the art may use different methods to implement the described functions for each specific application, but such implementation should not be considered to exceed the scope of the present disclosure.

The processes of the method or algorithm described in conjunction with the embodiments disclosed herein may be implemented directly by hardware, software modules executed by a processor, or a combination thereof. The software module may be placed in a random-access memory (RAM), a memory, a read-only memory (ROM), an electrically programmable ROM, an electrically erasable programmable ROM, a register, a hard disk, a removable disk, a CD-ROM, or any other form of storage medium known in the art.

The above description of the embodiments of the present disclosure enables those skilled in the art to implement or use the present disclosure. Various modifications to these embodiments will be obvious to those skilled in the art, and the general principles defined herein may be implemented in other embodiments without departing from the spirit or scope of the present disclosure. Therefore, the present disclosure will not be limited to the embodiments shown herein, but will conform to the broadest scope consistent with the principles and novel features disclosed herein.

What is claimed is:

1. A data processing method, comprising:
in response to a target instruction, determining an association parameter between input information and output information, the input information being information input to a target model, the output information being an output obtained after the input information is input to the target model, and the association parameter representing correlation between the input information and the output information; and
based on the association parameter, performing output processing on the input information and the output information.

2. The method according to claim 1, wherein determining the association parameter between the input information and the output information in response to the target instruction comprises:
in response to the target instruction being triggered by a user selecting all of the output information, determining a first association parameter between the input information and all of the output information; and
in response to the target instruction being triggered by the user selecting part of the output information, determining a second association parameter between the input information and partially selected target output information, and the target output information being part of the output information.

3. The method according to claim 2, wherein performing the output processing on the input information and the output information based on the association parameter comprises:
in response to the target instruction being triggered by the user selecting all of the output information, generating a first association form of the input information and all of the output information based on the first association parameter, superimposing and displaying the first association form on the input information and all of the output information, the first association form representing displaying the correlation between the input information and all of the output information with a specific display feature; and
in response to the target instruction being triggered by the user selecting part of the output information, generating a second association form of the input information and the target output information based on the second association parameter, superimposing and displaying the second association form on the input information and the target output information, the second association form representing displaying the correlation between the input information and the target output information with the specific display feature.

4. The method according to claim 1, wherein determining the association parameter between the input information and the output information in response to the target instruction further comprises:
in response to the target instruction being an instruction triggered before the input information and the output information are output, obtaining the association parameter between the input information and the output information based on configuration information of the target model, the association parameter including the first association parameter or the second association parameter, wherein the configuration information is a predefined default parameter to indicate the first association parameter between the input information and all of the output information, or the second association parameter between the input information and the target output information, and the target output information being part of the output information.

5. The method according to claim 4, wherein performing the output processing on the input information and the output information based on the association parameter further comprises:
generating the association form of the input information and the output information based on the association parameter, such that the correlation between the input information and the output information is displayed through the specific display feature, the association form representing processing the input information and the output information to be outputted with the specific display feature; and
synchronously outputting the association form when the input information and the output information are outputted.

6. The method according to claim 1, wherein determining the association parameter between the input information and the output information in response to the target instruction further comprises:
obtaining a weight matrix of a self-attention layer of the target model, an input vector corresponding to the input information, and an output vector corresponding to the output information, the weight matrix representing a degree of attention between the input vector and the output vector; and
determining the association parameter between the input information and the output information based on the weight matrix, the input vector, and the output vector.

7. The method according to claim 1, further comprising:
in response to performing the output processing on the input information and the output information based on the associated parameter, determining target input information in the input information based on the output processing information; and
adjusting the target input information to adjust the target model to obtain the adjusted target model.

8. A data processing apparatus, comprising:
a memory storing an application program; and
a processor coupled to the memory;
wherein when being executed by the processor, the application program causes the processor to:
in response to a target instruction, determine an association parameter between input information and output information, the input information being information input to a target model, the output information being an output obtained after the input information is input to the target model, and the association parameter representing correlation between the input information and the output information; and
based on the association parameter, perform output processing on the input information and the output information.

9. The apparatus according to claim 8, wherein when determining the association parameter between the input information and the output information in response to the target instruction, the processor is further configured to:
in response to the target instruction being triggered by a user selecting all of the output information, determine a first association parameter between the input information and all of the output information; and
in response to the target instruction being triggered by the user selecting part of the output information, determine a second association parameter between the input information and partially selected target output information, and the target output information being part of the output information.

10. The apparatus according to claim 9, wherein when performing the output processing on the input information and the output information based on the association parameter, the processor is further configured to:
in response to the target instruction being triggered by the user selecting all of the output information, generate a first association form of the input information and all of the output information based on the first association parameter, superimposing and displaying the first association form on the input information and all of the output information, the first association form representing displaying the correlation between the input information and all of the output information with a specific display feature; and
in response to the target instruction being triggered by the user selecting part of the output information, generate a second association form of the input information and the target output information based on the second association parameter, superimposing and displaying the second association form on the input information and the target output information, the second association form representing displaying the correlation between the input information and the target output information with the specific display feature.

11. The apparatus according to claim 8, wherein when determining the association parameter between the input information and the output information in response to the target instruction, the processor is further configured to:
in response to the target instruction being an instruction triggered before the input information and the output information are output, obtain the association parameter between the input information and the output information based on configuration information of the target model, the association parameter including the first association parameter or the second association parameter, wherein the configuration information is a predefined default parameter to indicate the first association parameter between the input information and all of the output information, or the second association parameter between the input information and the target output information, and the target output information being part of the output information.

12. The apparatus according to claim 11, wherein when performing the output processing on the input information and the output information based on the association parameter, the processor is further configured to:
generate the association form of the input information and the output information based on the association parameter, such that the correlation between the input information and the output information is displayed through the specific display feature, the association form representing processing the input information and the output information to be outputted with the specific display feature; and
synchronously output the association form when the input information and the output information are outputted.

13. The apparatus according to claim 8, wherein when determining the association parameter between the input information and the output information in response to the target instruction, the processor is further configured to:
obtain a weight matrix of a self-attention layer of the target model, an input vector corresponding to the input information, and an output vector corresponding to the output information, the weight matrix representing a degree of attention between the input vector and the output vector; and
determine the association parameter between the input information and the output information based on the weight matrix, the input vector, and the output vector.

14. The apparatus according to claim 8, wherein the processor is further configured to:
in response to performing the output processing on the input information and the output information based on the associated parameter, determine target input information in the input information based on the output processing information; and
adjust the target input information to adjust the target model to obtain the adjusted target model.

15. A non-volatile computer-readable storage medium storing a computer program, wherein when being executed by a processor, the computer program causes the processor to:
in response to a target instruction, determine an association parameter between input information and output information, the input information being information input to a target model, the output information being an output obtained after the input information is input to the target model, and the association parameter representing correlation between the input information and the output information; and
based on the association parameter, perform output processing on the input information and the output information.

16. The non-volatile computer-readable storage medium according to claim 15, wherein when determining the association parameter between the input information and the output information in response to the target instruction, the processor is further configured to:
in response to the target instruction being triggered by a user selecting all of the output information, determine a first association parameter between the input information and all of the output information; and
in response to the target instruction being triggered by the user selecting part of the output information, determine a second association parameter between the input information and partially selected target output information, and the target output information being part of the output information.

17. The non-volatile computer-readable storage medium according to claim 16, wherein when performing the output processing on the input information and the output information based on the association parameter, the processor is further configured to:
in response to the target instruction being triggered by the user selecting all of the output information, generate a first association form of the input information and all of the output information based on the first association parameter, superimposing and displaying the first association form on the input information and all of the output information, the first association form representing displaying the correlation between the input information and all of the output information with a specific display feature; and
in response to the target instruction being triggered by the user selecting part of the output information, generate a second association form of the input information and the target output information based on the second association parameter, superimposing and displaying the second association form on the input information and the target output information, the second association form representing displaying the correlation between the input information and the target output information with the specific display feature.

18. The non-volatile computer-readable storage medium according to claim 15, wherein when determining the association parameter between the input information and the output information in response to the target instruction, the processor is further configured to:
in response to the target instruction being an instruction triggered before the input information and the output information are output, obtain the association parameter between the input information and the output information based on configuration information of the target model, the association parameter including the first association parameter or the second association parameter, wherein the configuration information is a predefined default parameter to indicate the first association parameter between the input information and all of the output information, or the second association parameter between the input information and the target output information, and the target output information being part of the output information.

19. The non-volatile computer-readable storage medium according to claim 18, wherein when performing the output processing on the input information and the output information based on the association parameter, the processor is further configured to:
generate the association form of the input information and the output information based on the association parameter, such that the correlation between the input information and the output information is displayed through the specific display feature, the association form representing processing the input information and the output information to be outputted with the specific display feature; and
synchronously output the association form when the input information and the output information are outputted.

20. The non-volatile computer-readable storage medium according to claim 15, wherein when determining the association parameter between the input information and the output information in response to the target instruction, the processor is further configured to:
obtain a weight matrix of a self-attention layer of the target model, an input vector corresponding to the input information, and an output vector corresponding to the output information, the weight matrix representing a degree of attention between the input vector and the output vector; and
determine the association parameter between the input information and the output information based on the weight matrix, the input vector, and the output vector.
